(19) United States
(12) Patent Application Publication
(10) Pub. No.: US 2024/0158266 A1
(43) Pub. Date: May 16, 2024

(54) IN SITU REMOVAL OF SURFACE-ACTIVE COMPOUNDS FROM WATER

(71) Applicant: CDM Smith Inc., Boston, MA (US)

(72) Inventors: Dung Duc Nguyen, Bellevue, WA (US); Charles Edward Schaefer, JR., Edison, NJ (US)

(21) Appl. No.: 18/507,496

(22) Filed: Nov. 13, 2023

Related U.S. Application Data
(60) Provisional application No. 63/383,754, filed on Nov. 15, 2022.

(51) Int. Cl. C02F 1/40

(52) U.S. Cl. CPC C02F 1/40; C02F 2103/06

(57) ABSTRACT

Method for in situ removal of a surface-active compound, such as per- and polyfluoroalkyl substances (PFAS), from groundwater are described. A trench is prepared that is arranged to capture groundwater flow. A diffuser is placed in the trench. The trench is backfilled with a permeable, inert solid to an elevation below ground elevation. A platform that floats on water is placed within the trench. The platform includes a perimeter support structure and one or more perforated crossbeams connected to a vacuum source. A compressed gas is provided to the diffuser within the trench to generate a foam containing the surface-active compound above the groundwater. A vacuum is applied through the one or more perforated crossbeams of the platform to collect the foam containing the surface-active compound.

### RELATED APPLICATION

This application claims the benefit of U.S. Provisional Application No. 63/383,754, filed on Nov. 15, 2022. The entire teachings of the above application are incorporated herein by reference.

### BACKGROUND

Per- and polyfluoroalkyl substances (PFAS) are stable, persistent compounds that bioaccumulate in the environment. They are found in drinking water supplies, food products, and the blood of people and animals all over the world. PFAS are associated with a variety of human health risks. PFAS are stable and unreactive, and therefore are difficult to separate and remove from bulk water supplies. Removal of PFAS-impacted groundwater emanating from aqueous film-forming foam (AFFF) source areas has been challenging.

Currently available ex situ treatment approaches typically involve groundwater extraction and conventional sorption-based treatment of the extracted groundwater. Those approaches are generally inadequate for removing the high concentration of PFAS from AFFF-impacted groundwater, require extensive above- and under-ground infrastructure, and generate a large volume of PFAS-impacted waste that requires disposal or treatment. One example is US Patent Publication No. 2021/0300789 A1 (Phillips), which pertains to an apparatus and method for ex situ separation of PFAS from extracted groundwater.

US Patent Publication Nos. 2019/0176101 A1 (Phillips et al.) and 2019/0263679 A1 (Phillips et al.) pertain to an apparatus and method for separating an amount of a substance from groundwater. One significant limitation of this approach is that the groundwater subject to treatment is limited by the radius of influence of the extraction wells. Close spacing of the extraction wells is required to adequately capture and treat the entirety of a PFAS-impacted plume emanating from an AFFF source area.

Other conventional approaches to removal of PFAS include pump-and-treat approaches, which involve pumping water out of the ground and treating it (i.e., ex situ treatment).

### SUMMARY

The open sparge trench design and associated methods described herein allows for capture and treatment of groundwater emanating from an AFFF source area. The groundwater passes through the trench, and consequently the methods described herein are not limited by the radius of influence of extraction wells, as in US Patent Publication Nos. 2019/0176101 A1 (Phillips et al.) and 2019/0263679 A1 (Phillips et al.). In addition, the floating platform for the foam recovery system can move up and down with the groundwater table, thereby facilitating collection of the PFAS-containing foam that accumulates on top of the trench regardless of the groundwater table elevation. At sites with highly fluctuating groundwater elevations, a fixed foam recovery system may be susceptible to unwanted air and/or groundwater intrusion, which is not ideal because only the low volume of foam containing high concentrations of PFAS is desired to be collected.

The apparatus and methods described herein can be used to treat PFAS-containing groundwater in situ, passively, and economically with very little energy consumption, waste generation, and little to no chemical additives. The methods are passive in the sense that they do not require 24/7 monitoring by an onsite operator.

Described herein is a method of removing of a surface-active compound, such as per- and polyfluoroalkyl substances (PFAS), from groundwater. The method involves preparing a trench that is arranged to intercept groundwater flow; placing a diffuser within the trench; backfilling the trench with a permeable, inert solid to an elevation below ground elevation; placing a platform that floats on water within the trench, wherein the platform comprises a perimeter support structure and one or more perforated crossbeams connected to a vacuum source; providing a compressed gas to the diffuser within the trench to generate a foam above the groundwater; and applying a vacuum through the one or more perforated crossbeams of the platform to collect the foam containing the surface-active compound. The foam contains the surface-active compound.

The one or more perforated crossbeams can be perforated about midway from a position of the crossbeam proximal to the water and a position of the crossbeam distal to the water. The one or more perforated crossbeams can be perforated on an upper portion of the crossbeam that is distal to the water. In some embodiments, the one or more perforated crossbeams are not perforated on a lower portion of the crossbeam that is proximal to the water.

The method can include inserting one or more structural cross-supports to divide the trench into segments.

The method can include installing one or more piezometers within an upgradient section of the trench and one or more piezometers within a downgradient section of the trench. The method can include monitoring PFAS flux entering and exiting the trench via the one or more piezometer within the upgradient section of the trench and the one or more piezometers within the downgradient section of the trench.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a cross-sectional view of an air sparge trench according to embodiments disclosed herein.

FIGS. 2A-C illustrate a floating foam recovery system with perforated pipes. FIG. 2A is a top view of a floating foam recovery system with perforated pipes. FIG. 2B is a cross-sectional view of a floating foam recovery system with perforated pipes. FIG. 2C illustrates a trench divided into a plurality of compartments.

FIGS. 3A and 3B are embodiments of a floating foam recovery system.

FIG. 4 is a schematic that illustrates a trench that is downstream in the flow of groundwater.

### DETAILED DESCRIPTION

A description of example embodiments follows.

The methods and apparatuses described herein utilize a sparge trench coupled with foam fractionation and foam recovery/reconstitution to remove a surface active compound, such as PFAS, from groundwater. The foam is recovered through use of a platform that floats on water and has perforated support beams connected to a vacuum source. The techniques described herein address shortcoming of existing methods for collection and removal of PFAS-containing foam.

Compared to in situ foam fractionation techniques that require installing a large number of extraction wells to adequately capture the PFAS-containing groundwater plume emanating from an AFFF source area, the techniques described herein are not limited by the radius of influence of the extraction wells and can be used to adequately capture and treat PFAS-impacted groundwater in situ.

In real-world in situ applications, the elevation of the groundwater table fluctuates. For example, seasonal fluctuations in groundwater elevation are commonly observed at many sites. This fluctuation makes it difficult to collect and remove PFAS-containing foam from a stationary collection device. The floating platform described herein enables collection of the PFAS-containing foam even when the elevation of the groundwater table fluctuates.

While aspects are described herein in relation to PFAS, the techniques are applicable to a variety of surface-active compounds. Surface-active compounds preferentially adsorb at an air-liquid, liquid-liquid, or liquid-solid interfaces. The surface-active compounds that can be removed by the methods described herein are amphiphilic, meaning that they have both a hydrophilic group and a hydrophobic group.

Once an area to be treated is identified, the flow of groundwater should be evaluated to determine the direction and velocity of groundwater flow. In many areas, it is not uncommon for groundwater to flow along more than one pathway or direction. After the flow of groundwater is determined, a trench is installed downgradient of an AFFF source area so that groundwater flows from the AFFF source area into the sparge trench for treatment. Typically, though not necessarily, the length of the trench is substantially perpendicular to the groundwater flow direction.

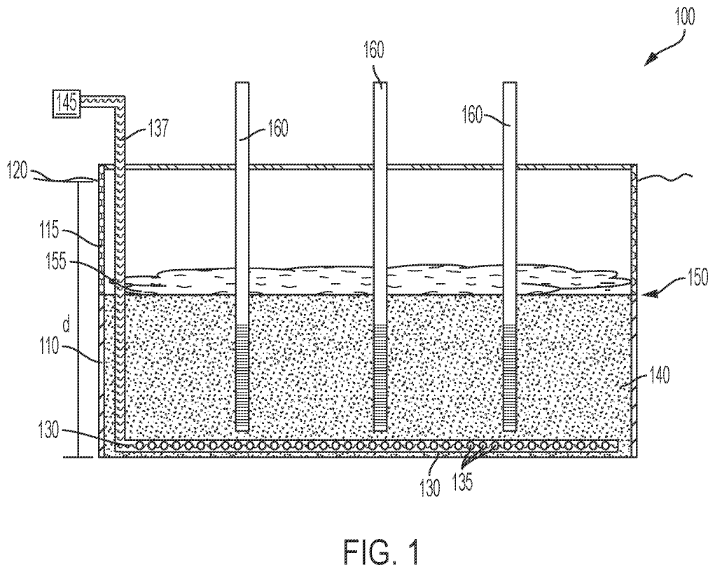

FIG. 1 is a cross-sectional view of a trench 100 that is installed to a depth, d, below the grade 120. The trench should be below the static water table, and the trench depth is usually site-specific and can depend on the geography and zone of interest. Depending on the trench installation technique used, the maximum depth ranges from approximately 10 to 60 feet below the ground surface. The width of the trench, which is typically substantially parallel to groundwater flow, is typically kept to a minimum to reduce the volume of material that is excavated during trench installation and to minimize the overall installation cost. Site-specific groundwater velocity can be used to determine the appropriate trench width to allow for sufficient treatment/residence time within the trench. In some embodiments, the trench is from about 1 foot wide to about 5 feet wide. In some embodiments, the trench is from about 25 feet long to about 250 feet long.

Geotextile 110 is typically installed along the side of the trench to prevent fines (e.g., fine sediment) from entering the trench, where it would block or reduce the flow of groundwater into the area that has been backfilled 140. Sheet pile 115 is typically installed to facilitate excavation of the trench. A diffuser 130 having a plurality of perforations 135 is placed in the trench. The diffuser 130 is connected via piping 137 to a source of compressed gas 145. The diffuser 130 can be one or more perforated pipes, as illustrated in FIG. 1. In other embodiments, the diffuser 130 can be one or more ceramic diffusers, such as those commonly used in ozonation applications. After the diffuser is installed, the trench is backfilled with a permeable, inert solid 140, such as such as gravel or a synthetic material. Backfilling provides structural integrity to the trench once the sheet piles are removed following excavation. The trench is typically backfilled to just below the lowest level of the water table 150 so that the PFAS-containing foam accumulates on the water surface, just above the water table level rather than within the backfill material. The trench 100 is an open trench, meaning that it is not backfilled all the way to the top. Because there is an open space between the water table and the surface of the ground, there is an area in which the foam can accumulate for recovery.

Optionally, one or more PVC pipes 160 can be installed as piezometers within the trench prior to backfilling with the porous, inert solid 140 in order to allow for groundwater sample collection and to monitor treatment performance. Soils immediately upgradient or downgradient of the trench may be significantly contaminated with PFAS, and thus are susceptible to slow PFAS desorption. Therefore, monitoring wells installed outside of the sparge trench may not be used to accurately quantify PFAS removal efficacy. On the other hand, piezometers installed within upgradient and downgradient sections of the trench, such as on the upgradient edge and the downgradient edge within the confines of the trench, can be used to measure the PFAS flux entering and exiting the trench, respectively.

In operation, compressed gas flows through the piping 137 to the diffuser 130, resulting in bubbles of gas that emanate from the diffuser 130. Typically, the compressed gas is provided by a compressor, though it is also possible to use tanks of compressed gas. PFAS are surface-active compounds with high affinity for air-water interfacial adsorption. During active operation, the PFAS present in the impacted groundwater become attached to the air bubbles and are transported to the top of the water column where they accumulate and become enriched in the foam phase. The flow rate of the compressed gas is limited so that aeration does not cause the PFAS foam to become airborne upon reaching the top. Removal of the PFAS-containing foam can result in multiple orders of magnitude reduction of PFAS in the bulk groundwater.

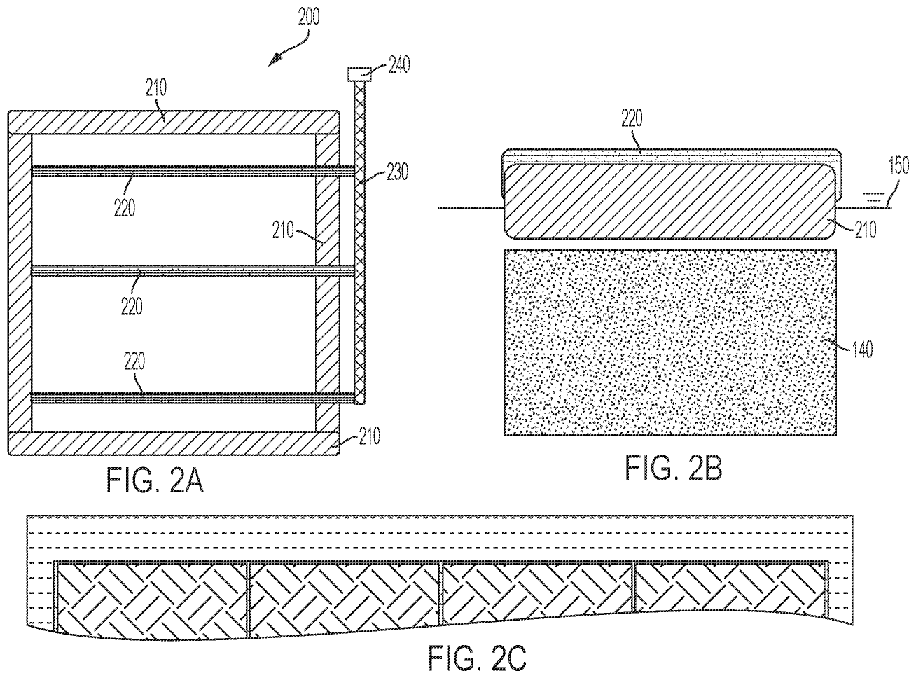

To collect the PFAS-containing foam, a floating platform is placed on top of the water. FIGS. 2A and 2B illustrate a top-view and a cross-sectional view, respectively, of a platform 200 that floats on top of the water. The platform includes one or more perimeter support structures 210. In example embodiments, the perimeter support structures can be formed of hollow polyvinyl chloride (PVC) piping or tubing. Optionally, the perimeter support structure 210 can be outfitted with one or more buoyant devices 215, such as a polyethylene foam that surrounds (or partially surrounds) a perimeter support structure 210 for additional buoyancy. On top of the perimeter support structures 210 are one or more crossbeams 220 with perforations 225 for collecting PFAS-containing foam. The perforated crossbeams 220 are connected via tubing 230 to a vacuum source 240.

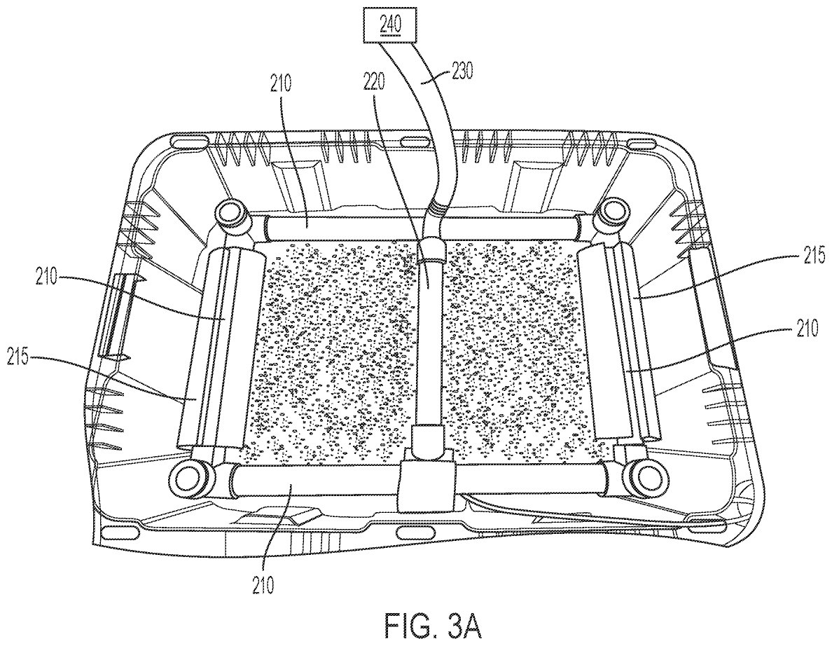

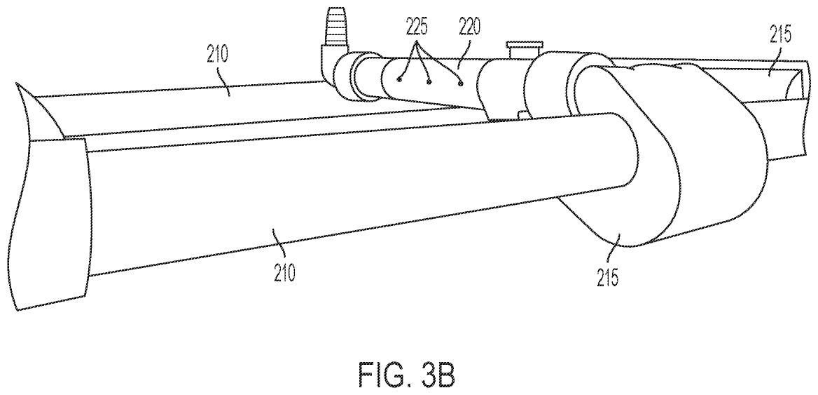

This arrangement of the support structures 210 and perforated pipes 220 is important because it elevates the perforated pipes above the water surface, thereby facilitating collection of the PFAS-containing foam while reducing the likelihood that water is collected. The arrangement of perforated crossbeam 220 above, but proximate to, the water level is significant because it allows effective capture of the PFAS-containing foam by the vacuum source 240. The extent to which the vacuum can effectively reach the PFAS-containing foam is not limited by the size or number of stationary vacuum suction hoods (or similar devices). In other words, the entirety of the cross-section of the platform can be used for vacuum extraction. In some embodiments, a plurality of perforated crossbeams can be connected to a single vacuum source through a manifold, thereby improving collection efficacy and efficiency. Accidental capture of near-surface water with little PFAS rather than the highly concentrated PFAS-containing foam results in a higher volume of waste that would ultimately require treatment or destruction. Therefore, maximum capture of the foam with little to no accidental capture of the near-surface water is desirable. As illustrated in FIG. 3B, the perforations 225 are arranged about midway from a position of the crossbeam proximal to the water and a position of the crossbeam distal to the water. This arrangement helps facilitate removal of foam without collection of near-surface water.

In some embodiments, the perforated crossbeams 220 are perforated on the upper portion of the crossbeam. In some embodiments, the perforated crossbeams 220 not perforated on the lower portion of the crossbeam. Both of these arrangements facilitate collection of PFAS-containing foam while reducing the amount of water collected.

After removal by the vacuum source 240, the PFAS-containing foam is collected in a storage container. Once collected, the PFAS-containing foam can be subject to offsite disposal or onsite treatment using available PFAS-destructive technologies. If desired, the collected foam can be subject to ex situ foam fractionation to reduce the volume of waste requiring onsite/offsite disposal/destruction.

FIGS. 3A and 3B are embodiments of a floating platform made from PVC piping. The center cross beam has 6× 1/16″ perforations and is connected by a hose to a vacuum source. In testing performed by applying 150 mmHg of vacuum, most of the PFAS-containing foam was recovered within 10 minutes.

In some embodiments, such as in FIG. 3A, the floating platform has only a single vacuum cross beam. Other embodiments can have a plurality of cross-beams that are connected to a vacuum source. These can be either a plurality of vacuum sources or a single vacuum sources connected to a plurality of cross-beams via a manifold.

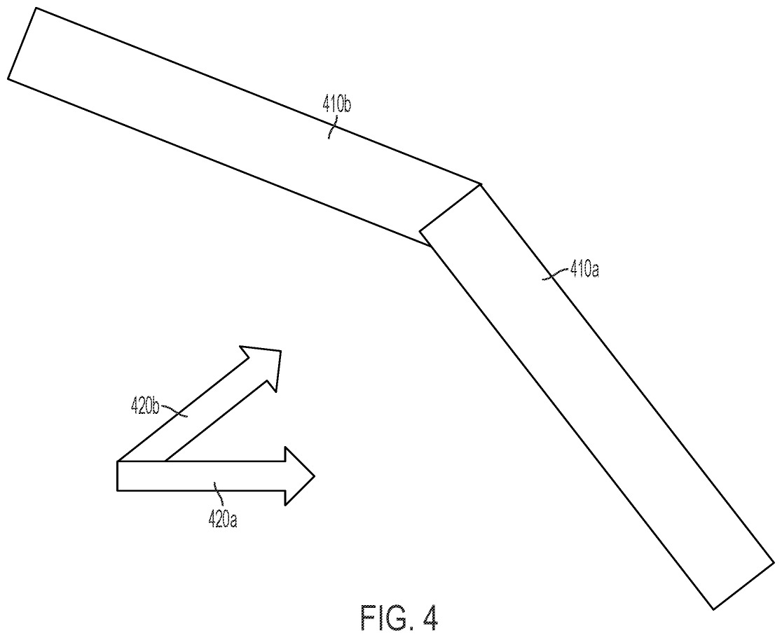

FIG. 4 illustrates two intersecting trenches 410a and 410b that are positioned substantially perpendicular and downgradient from the groundwater flow, illustrated by arrows 420a and 420b. In this manner, the trench (or trenches) collect the natural groundwater flow. While FIG. 4 illustrates two substantially linear trenches, one or more curved trenches can be used, or in some embodiments a single curved trench can be used. Oftentimes, it is preferable to divide a trench into a plurality of segments, as illustrated in FIG. 2C, by inserting a non-porous, structural cross-support into the trench to improve structural integrity of the trench. In some embodiments, the segments can be approximately six feet in length.

### INCORPORATION BY REFERENCE; EQUIVALENTS

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A method of removing of a surface-active compound from groundwater, the method comprising:
a) preparing a trench that is arranged to capture groundwater flow;
b) placing a diffuser within the trench;
c) backfilling the trench with a permeable, inert solid to an elevation below ground elevation;
d) placing a platform that floats on water within the trench, wherein the platform comprises a perimeter support structure and one or more perforated crossbeams connected to a vacuum source;
e) providing a compressed gas to the diffuser within the trench to generate a foam above the groundwater, wherein the foam contains the surface-active compound; and
f) applying a vacuum through the one or more perforated crossbeams of the platform to collect the foam containing the surface-active compound.

2. The method of claim 1, wherein the one or more perforated crossbeams are perforated about midway from a position of the crossbeam proximal to the water and a position of the crossbeam distal to the water.

3. The method of claim 1, wherein the one or more perforated crossbeams are perforated on an upper portion of the crossbeam that is distal to the water.

4. The method of claim 1, wherein the one or more perforated crossbeams are not perforated on a lower portion of the crossbeam that is proximal to the water.

5. The method of claim 1, further comprising inserting one or more structural cross-supports to divide the trench into segments.

6. The method of claim 1, further comprising installing one or more piezometers within an upgradient section of the trench and one or more piezometers within a downgradient section of the trench.

7. The method of claim 6, further comprising monitoring flux of the surface-active compound entering and exiting the trench via the one or more piezometer within the upgradient section of the trench and the one or more piezometers within the downgradient section of the trench.

8. The method of claim 1, wherein the surface active compound comprises per- and polyfluoroalkyl substances (PFAS).
